(19) United States
(12) Patent Application Publication
(10) Pub. No.: US 2009/0047646 A1
(43) Pub. Date: Feb. 19, 2009

(54) TEACHING METHOD AND APPARATUS FOR SHOELACE TYING

(76) Inventors: Traci Porter, Overland Park, KS (US); Jason Porter, Overland Park, KS (US)

Correspondence Address: HOVEY WILLIAMS LLP, 10801 Mastin Blvd., Suite 1000, Overland Park, KS, 66210, US

(21) Appl. No.: 11/840,673

(22) Filed: Aug. 17, 2007

(51) Int. Cl. G09B 19/24

(52) U.S. Cl. 434/260

(57) ABSTRACT

An instructional shoelace (20,52) is provided having a shoelace body (26,54) presenting a central section (28) and first and second tie sections (30,32), wherein the first tie section (30) has a distinct, perceptible identifier (34) that serves to distinguish the first tie section (30) from the second tie section (32). Preferably, the second tie section (32) has a pair of spaced identifiers (36,38). In use, the central section (28) is threaded through the eyelets (84) of a tie shoe (82) leaving the first and second tie sections (30,32) extended from the eyelets (84). The tie sections (30,32) are crossed over each other to form a crossing (86), and the second tie section (32) is looped to form loop (88). The first tie section (30) is passed around the loop (88) to present a portion (90) between the loop (88) and crossing (86). Thereupon, the loop (88) and portion (90) are pulled in opposite directions to complete the tie. The use of a uniquely identified first section (30) permits an individual learning to tie shoelaces to first grasp the second section (32) to form loop (88), and then to grasp first section (30) to complete the tie. In this way much of the confusion and complexity of shoelace tying is eliminated, allowing the individual more rapidly learn the shoelace tying skill.

### BACKGROUND OF THE INVENTION

1. Field of the Invention

The present invention is broadly concerned with instructional shoelaces that assist an individual (e.g., a child or handicapped person) in learning to tie shoes. More particularly, the invention pertains to such instructional shoelaces having a unique, perceptible identifier that distinguishes the first and second tie sections of the shoelace when applied to a tie shoe. The invention also is directed to combinations of tie shoes and instructional shoelaces, methods of tying shoes, and to kits allowing conventional shoelaces to be modified in accordance with the invention.

2. Description of the Prior Art

One of the most trying aspects of childhood is learning to tie one's shoes. While a simple task for an adult, shoe tying can be bewilderingly complex for a young child. The child is presented with a pair of shoelace ends or tie sections and must, in proper sequence, grasp the correct tie section and manipulate the sections in a specific order. These problems are compounded because of the fact that such young children have small hands and fingers and lack the eye-hand coordination of adults.

Adults attempting to teach children how to tie shoes are often frustrated because, while they can tie their own shoes with little thought about the process, efforts to explain to children the steps of shoe tying can be difficult. Additionally, adults often tie children's shoes while facing the child, whereas the learning child confronts shoelaces from the opposite direction. Thus, the sequence of steps must be effectively reversed from what the child observes with an adult tying his or her shoes.

Efforts have been made in the past to assist individuals in learning to tie shoes. U.S. Pat. No. 5,778,499, describes a shoelace provided with tie sections having engageable VELCRO® hook and loop sections on each tie section. These shoelaces are designed to facilitate loop formation during the initial step of shoe tying. However, the hook and loop fastener arrangement does not distinguish between the individual tie sections of the shoelace.

There is accordingly a need in the art for an improved instructional shoelace and method that provides a unique identification of the individual tie sections of a shoelace, allowing the learner to readily know the difference between the tie sections, and thus facilitating the task of shoe tying.

### SUMMARY OF THE INVENTION

The present invention overcomes the problems outlined above by providing an instructional shoelace comprising an elongated flexible body presenting a pair of tips respectively adjacent each end of the body, the body having a central section adapted to be threaded through the eyelets of a tie shoe, and first and second tie sections between the central section and the tips. The first tie section has a distinct, perceptible identifier located between the central section and the tip of the first tie section, wherein the identifier is operable to identify the first tie section and to distinguish the first tie section from the second tie section. Preferably, the second tie section also has a pair of spaced apart perceptible identifiers thereon between the central section and the second tie section tip. These second tie section identifiers are located on opposite sides of the first tie section identifier, when the tips are placed adjacent each other and the shoelace is drawn taut. The preferred tie section identifiers are in the form of rivet assemblies or snaps applied to a shoelace at strategic locations. Advantageously, the identifiers for the instructional shoelaces consist of a single identifier on the first tie section and a pair of spaced identifiers on the second tie section.

The invention also provides tie shoe assemblies including a tie shoe having a series of shoelace-receiving eyelets, and an instructional shoelace of the type described threaded through the eyelets and presenting first and second opposed tie sections extending from the eyelets. Such an assembly can be used in a method of tying the shoelace, so as to facilitate the learning of this skill. Such method preferably involves crossing the first and second tie sections, followed by grasping the second tie section (which is readily identified owing to the unique identification of the first tie section) and forming a loop. Thereupon, the first tie section is grasped and passed around the loop so that a portion of the first tie section is disposed between the crossing and the loop. Finally, the loop and first tie section portion are pulled in opposite directions to complete the tying of the shoelace. The initial loop-forming step is preferably accomplished by placing the two identifiers on the second tie section in close adjacency. In this way, a properly sized and located loop is assured.

The invention also provides a kit for modifying a conventional shoelace so as to form an instructional shoelace useful to assist a person in learning to tie shoelaces. The conventional shoelace typically is in the form of an elongated flexible body presenting a pair of tips adjacent each end of the body, the body having a central section adapted to be threaded through the eyelets of a tie shoe, and first and second tie sections between the central section and the tips. The kit of the invention comprises a first distinct, perceptible identifier attachable to the first tie section between the central section and the tip thereof, wherein the identifier is operable to identify the first tie section and to distinguish the first tie section from the second tie section. In embodiments of the invention, the kit also includes a location guide for placement adjacent the first tie section and has a first marking thereon that identifies the proper location of the first identifier on the first tie section. The guide is preferably in the form of an elongated card imprinted with markings to orient the card relative to the shoelace being modified and to illustrate the proper location for the first tie section identifier; the card also preferably includes markings for the spaced identifiers on the second tie section. In other embodiments of the invention, the location guide of the kit includes an elongated tri-fold having the identifiers placed thereon in the preferred location and further having securement clips for holding the shoelace taught while positioning the identifiers on the shoelace.

### BRIEF DESCRIPTION OF THE DRAWINGS

FIG. 1 is a plan view of a child's tie shoe, having an instructional shoelace in accordance with the invention threaded through the eyelets of the shoe and with the tie sections of the shoelace extended;

FIG. 2 is a plan view similar to that of FIG. 1, but depicting the first step in the tying operation wherein the tie sections of the instructional shoelace are crossed;

FIG. 3 is a fragmentary, enlarged plan view of the shoe depicted in FIG. 1, and showing the next step in the tying operation wherein a loop is formed using the second tie section, the first tie section is passed around the loop, and a portion of the first tie section is positioned between the loop and the crossing of the tie sections;

FIG. 4 is a view similar to that of FIG. 3, and showing the next step in the tying operation wherein the loop formed in the second tie section and the portion of the first tie section are pulled in opposite directions to complete the tie;

FIG. 5 is an enlarged, plan view of the shoe of FIG. 1, showing the instructional shoelace fully tied;

FIG. 6 is an exploded, perspective view illustrating an instructional shoelace in accordance with the invention, with one of the rivet identifiers in exploded condition;

FIG. 7 is an enlarged, fragmentary perspective view depicting one of the rivet identifiers secured to the instructional shoelace of FIG. 6;

FIG. 8 is a vertical, sectional view taken along line 8-8 of FIG. 7, and illustrating the construction of the identifying rivet;

FIG. 9 is an exploded, perspective view of another instructional shoelace in accordance with the invention, wherein the shoelace is flat and the identifying rivets are provided with surface decoration;

FIG. 10 is a view similar to that of FIG. 7, and illustrating the identifying rivet in greater detail;

FIG. 11 is a fragmentary, perspective view depicting the underside of the rivet illustrated in FIG. 10;

FIG. 12 is a vertical, sectional view taken along line 12-12 of FIG. 10;

FIG. 13 is a plan view of an instructional shoelace in accordance with the invention, shown with the shoelace tips in adjacency with the shoelace pulled taut to illustrate the positions of the identifying rivets on the shoelace;

FIG. 14 is a plan view illustrating use of a kit in accordance with embodiments of the invention, wherein a location guide is positioned adjacent a shoelace, with the guide having markings thereon locating the proper positions of the identifying rivets;

FIG. 15 is a left-side view of a tie shoe and further illustrating use of a kit in accordance with other embodiments of the invention, wherein a location guide comprising a tri-fold is positioned adjacent a tongue of the shoe and the shoelaces are secured within the tri-fold; and

FIG. 16 is a fragmentary, perspective view of the tri-fold illustrated in FIG. 15 and further illustrating shoelaces secured within the tri-fold and a location of the identifiers on the tri-fold.

### DETAILED DESCRIPTION OF THE PREFERRED EMBODIMENT

The present invention provides instructional shoelaces that are threaded into otherwise conventional tie shoes in order to assist an individual in learning to tie shoes. The invention is also concerned with tie shoe assemblies including the instructional shoelaces, methods of tying shoelaces using such assemblies, and kits for modifying conventional shoelaces in accordance with the invention.

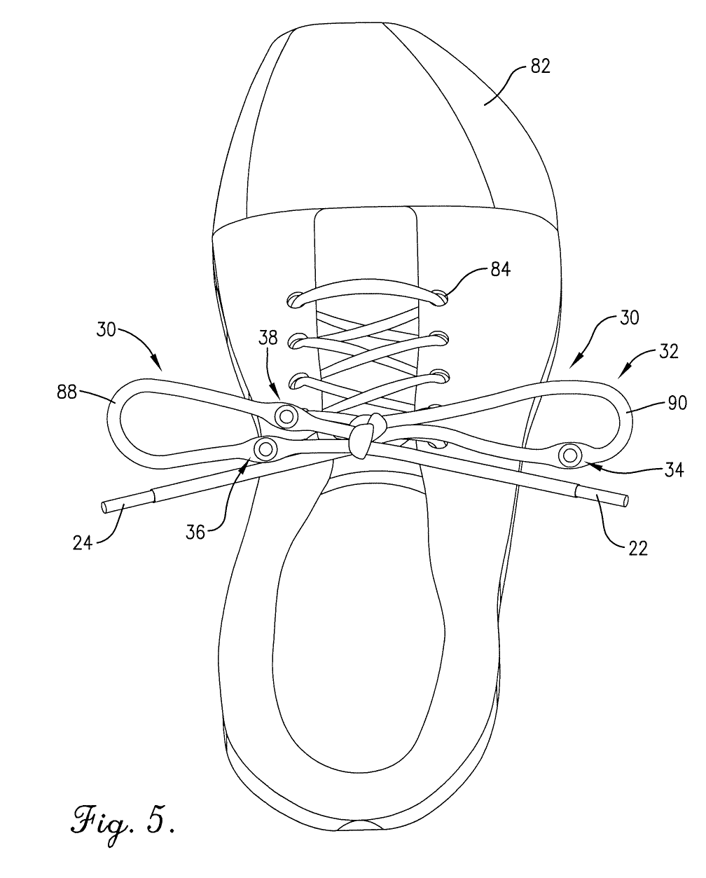

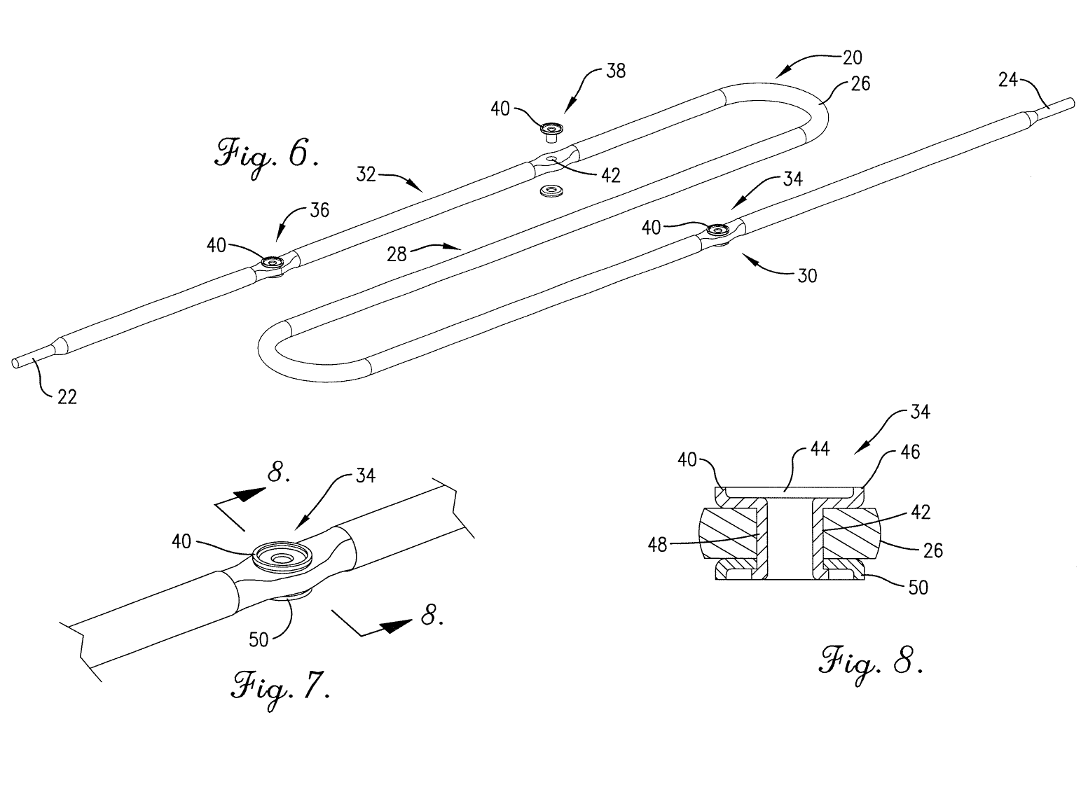

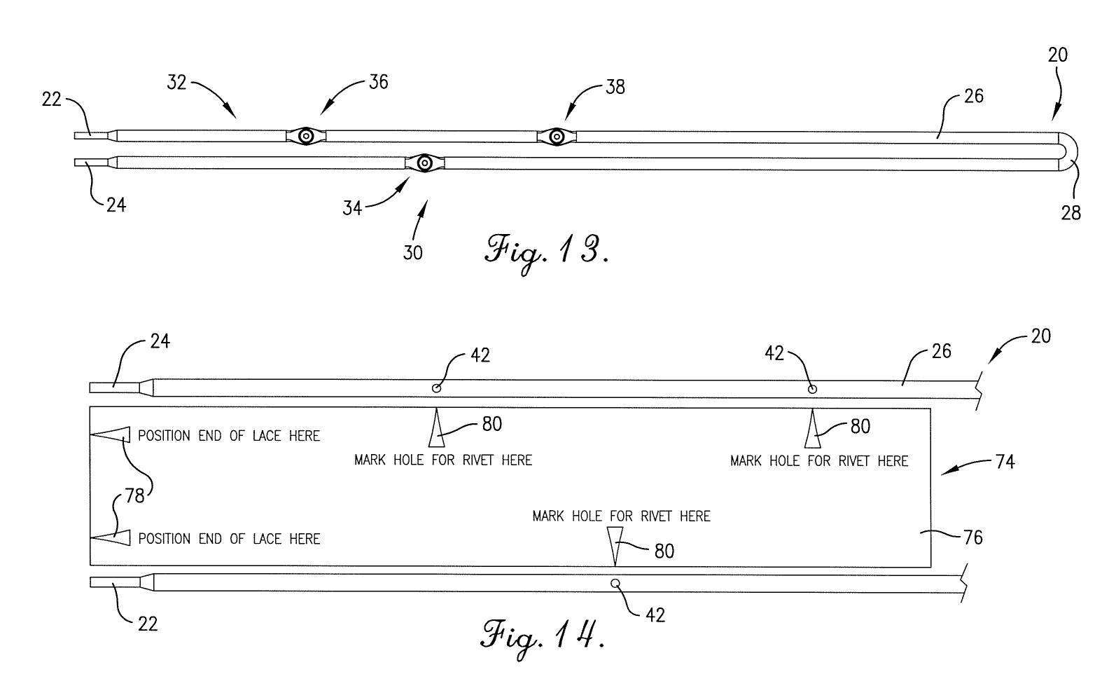

Turning first to FIGS. 6-8 and 13, an instructional shoelace 20 is illustrated. The shoelace 20 in this instance is a round, cord-type shoelace presenting endmost tips 22 and 24 (also commonly referred to as aglets) and an elongated body 26 (see FIG. 6) formed of round, flexible fabric or like shoelace material between the tips 22,24. As will be explained in greater detail, the shoelace 20 has a central section 28 adapted to be threaded through the eyelets of a tie shoe, as well as first and second tie sections 30 and 32, as illustrated in FIG. 6. The tie section 30 has a first, single identifier 34, whereas the second section 32 has a pair of spaced apart, second and third identifiers 36,38. In both cases the identifiers 34-38 are distinct and perceptible, and serve to identify the first tie section 30 and to distinguish it from the second tie section 32. Referring to FIG. 13, it will be seen that when the shoelace 20 is positioned so that tips 22,24 thereof are juxtaposed and the body 26 is pulled taut, the first identifier 34 of first tie section 30 is located approximately midway between the second and third identifiers 36,38 of second tie section 32.

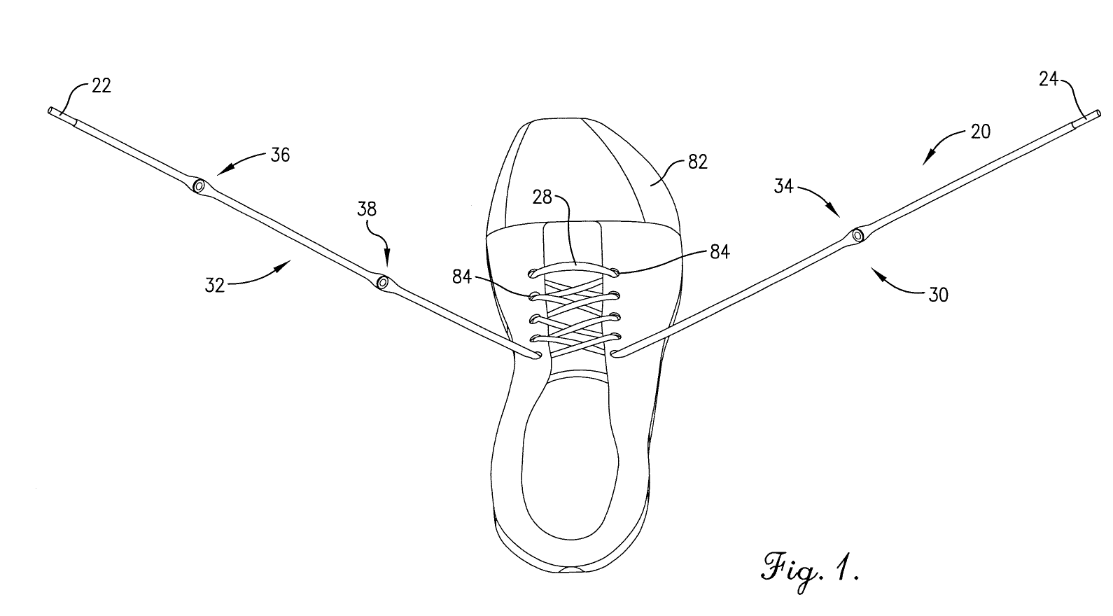

In embodiments of the present invention and as illustrated in FIG. 1, when the shoelace 20 is threaded through the eyelets 84 of the tie shoe, the second identifier 36 is located approximately one-fourth to one-half, and preferably approximately one-third, the length of the second section 32 from the second section 32 end having the tip 22. Additionally, the third identifier 38 is located approximately one-fourth to one-half, and preferably approximately one-third, the length of the second section 32 from the second section 32 end proximal to the shoe. The length of shoelace 20 between the tip 22 and the second identifier 36 is approximately the same as the length of shoelace 20 between the second identifier 36 and the third identifier 38. Similarly, for the first section 30, the first identifier 34 is positioned approximately midway along the length of the first section 30 when measured from the eyelets 84 to the tip 24.

In the illustrated embodiment, each of the identifiers 34-38 is in the form of a metallic rivet assembly 40 (see FIGS. 7-8). The rivet assembly is designed to be positioned through a hole 42 through the body 26 at a selected location, as discussed in more detail below. As illustrated in FIG. 8, the rivet assembly 40 includes an upper segment 44 having a radially enlarged portion 46 as well as a depending, hollow leg 48. The rivet assembly 40 also includes a lower annular segment 50 designed to receive and interfit with the lower end of leg 48, so as to affix the assembly 40 in place on shoelace body 26. Attachment of the rivet assemblies 40 involves placement of the lower segment 50 beneath hole 42, followed by insertion of leg 48 through the hole. A light hammer tap is then applied to the upper segment to effect a frictional fit connection between leg 48 and segment 50, as depicted in FIG. 8.

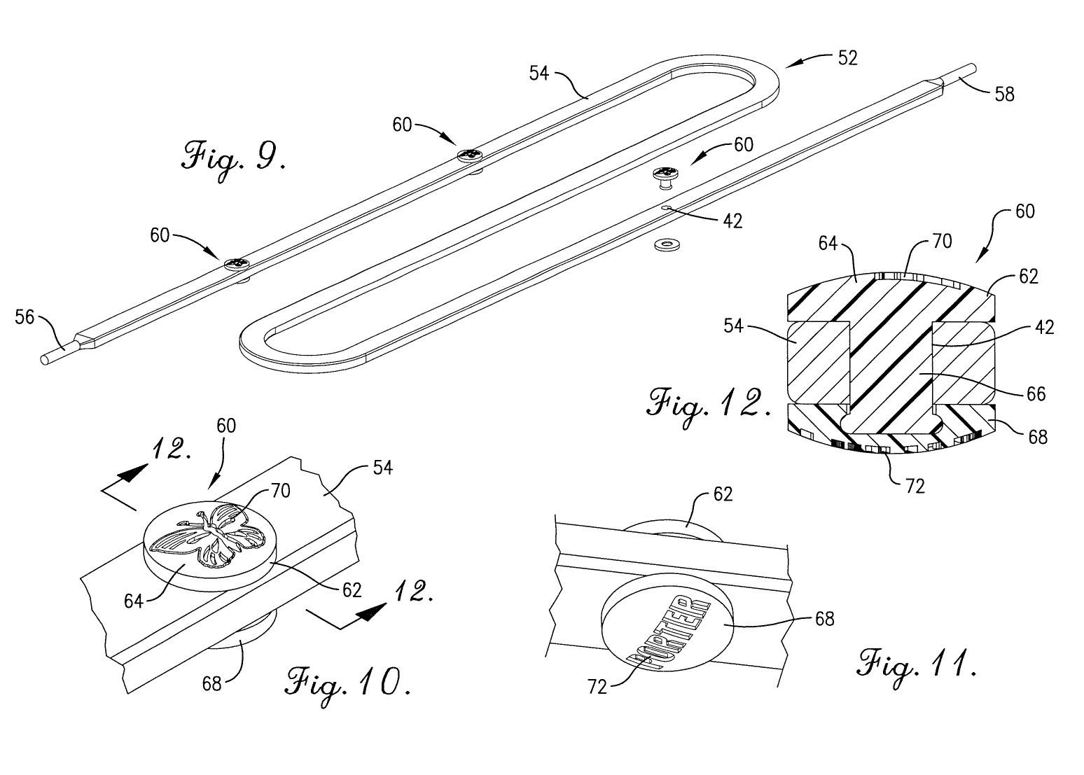

It will of course be appreciated that a wide variety of different shoelaces and identifiers may be used. For example, FIGS. 9-12 illustrate a shoelace 52 which is similar to shoelace 20, except that the shoelace 52 has a flat flexible body 54 with endmost tips 56 and 58. Also, in this embodiment, specialized rivet assemblies 60 are used in lieu of assemblies 40. In all other particulars, the shoelace 52 is identical with shoelace 20. Referring to FIGS. 10-12, it will be observed that each rivet assembly 60 includes an upper segment 62 having a domed portion 64 and a solid depending leg 66 adapted to be passed through hole 42 formed in the shoelace body. A domed, lower segment 68 is also provided and interfits with leg 66 to complete the connection of the rivet assembly 60 to the shoelace body 54. The upper segment 64 is decorated with a butterfly design 70, whereas bottom segment 66 has a name “Porter” 72 inscribed thereon. It will of course be appreciated that any desired decoration and/or name could be applied to the rivet assembly 60 of this embodiment. Attachment of the rivet assemblies 60 is accomplished in the same manner as with the assemblies 40.

As indicated, embodiments of the present invention further provide a kit for allowing an otherwise conventional shoelace to be modified in order to yield an instructional shoelace such as shoelace 20. Broadly, embodiments of such kits, as illustrated in FIGS. 13-14, include an appropriate number of identifiers, along with a location guide or template 74 permitting proper location and attachment of the identifiers to a shoelace. An embodiment of such a guide 74 is depicted in FIG. 14, during use thereof to assist in shoelace modification to yield instructional shoelace 20. The guide 74 is preferably in the form of a rectangular card 76 having appropriate location indicia thereon. In this embodiment, the card 76 has imprinted thereon, adjacent the left hand end of the card, two marker arrows 78 and inscriptions reading “Position End of Lace Here.” In addition, along the length of card 76 three marker arrows 80 are provided along with the inscription “Mark Hole for Rivet Here.” These marker arrows 80 of course correspond to the desired positions for the identifiers 34-38. In use, a shoelace is positioned as depicted in FIG. 14, with the tips 22,24 thereof adjacent the left hand end of card 76, and with shoelace body 26 extending along the length of the card.

Using the guide 74, the holes 42 are formed in the shoelace body at the locations indicated by the marker arrows 80. After the holes 42 are formed, the rivet assemblies 40 are secured to the shoelaces as described previously.

The kit may also include a hole-stamping device (not shown) for forming the holes 42 in the shoelace 20. The device may comprise an elongated, circular body have a cutting or stamping end. The stamping end may include a circular stamping blade of a diameter sized to accommodate the leg 48 of the rivet assembly 40. A user would use the hole-stamping device to stamp or otherwise form the holes 42 in the shoelace 20 by positioning the stamping end of the device against the shoelace 20 at the desired location for the hole 42 and applying pressure in a direction perpendicular to a longitudinal axis of the device so as to stamp out the hole 42. In other embodiments, the kit of the present invention includes shoelaces 20 having pre-formed holes and even pre-positioned identifiers 34-38.

The kit further includes an instruction guide providing directions for using the present shoelace tying method, as provided below. The instruction guide preferably provides a set of step-by-step instructions so that a user may know how to apply and otherwise manipulate the instructional shoelace 20 of the present invention.

FIGS. 1-5 illustrate the use of the instructional shoelace 20 in assisting a person in learning to tie shoes. Referring first to FIG. 1, a conventional tie shoe 82 is provided having a series of shoelace-receiving eyelets 84 in the vamp of the shoe. The central section 28 of the shoelace 20 is threaded through the eyelets 84, leaving the first and second tie sections 30,32 extending from the eyelets.

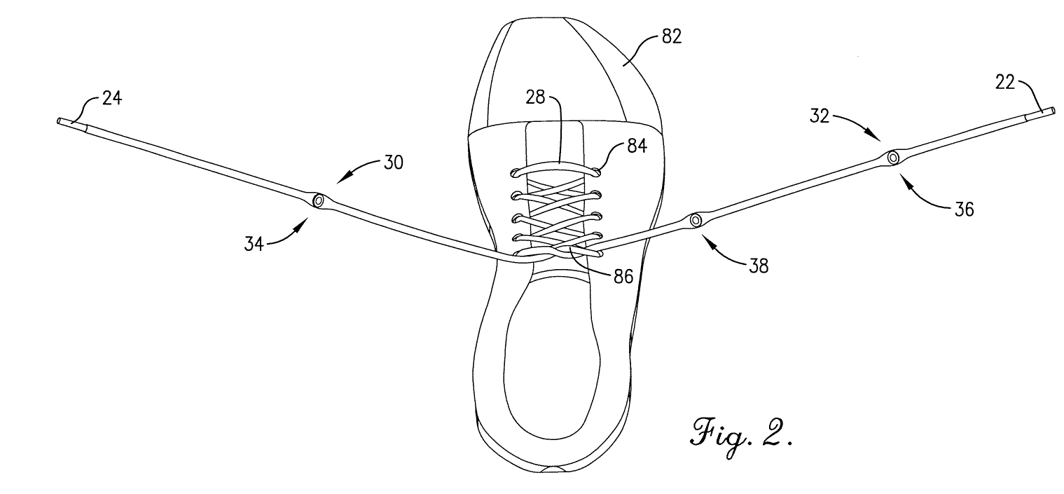

In the first step, the tie sections 30,32 are crossed over each other to form a crossing 86 adjacent the upper end of the eyelets 84, as illustrated in FIG. 2. As a result of such crossing 86, the tie sections 30,32 extend in opposite directions, as compared with the FIG. 1 illustration. In the next step, the user grasps the second tie section 32 and forms a loop 88 therein. Desirably, the loop is dimensioned such that the identifiers 36,38 are in close adjacency as illustrated in FIG. 3. At the same time, the first section 30 is passed around the base of the formed loop 88 to present a portion 90 close to identifier 38 which is located between the loop 88 and crossing 86.

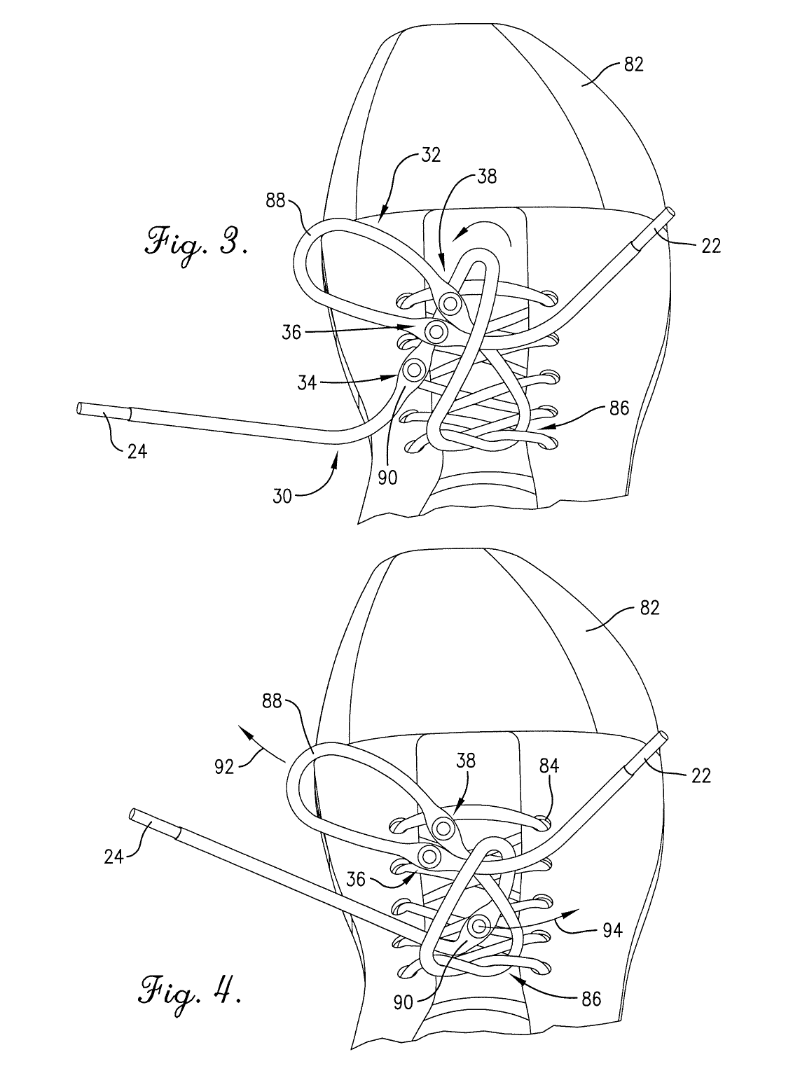

Next, the user grasps the outer end of loop 88 and the portion 90 and pulls these in opposite directions, such that the portion 90 passes between loop 88 and crossing 86. This action is illustrated by arrows 92 and 94 (see FIG. 4). Such pulling action completes the tie, drawing the shoelace together as illustrated in FIG. 5.

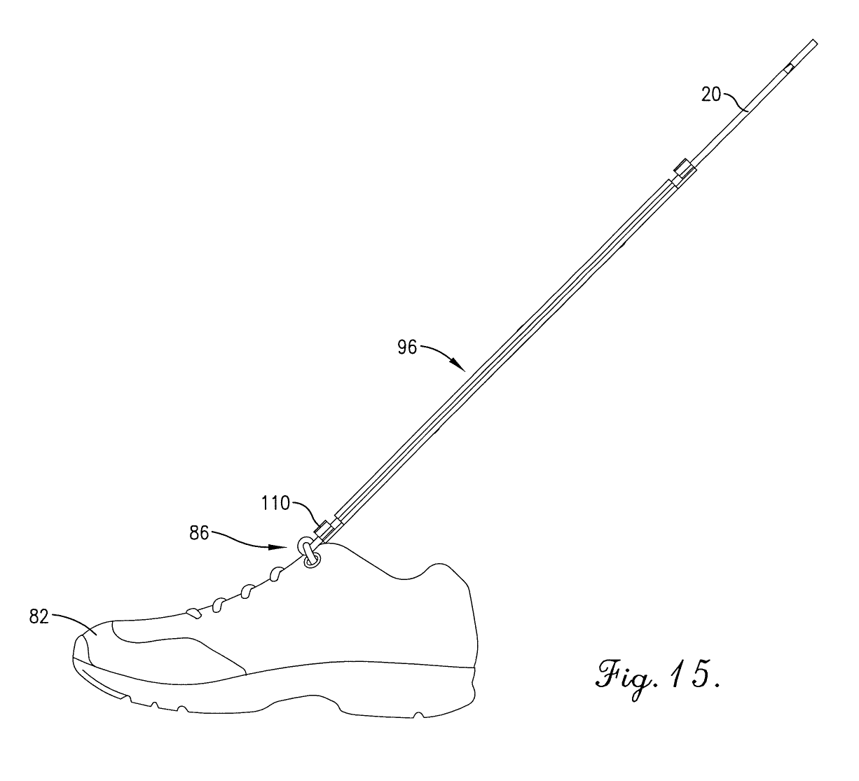

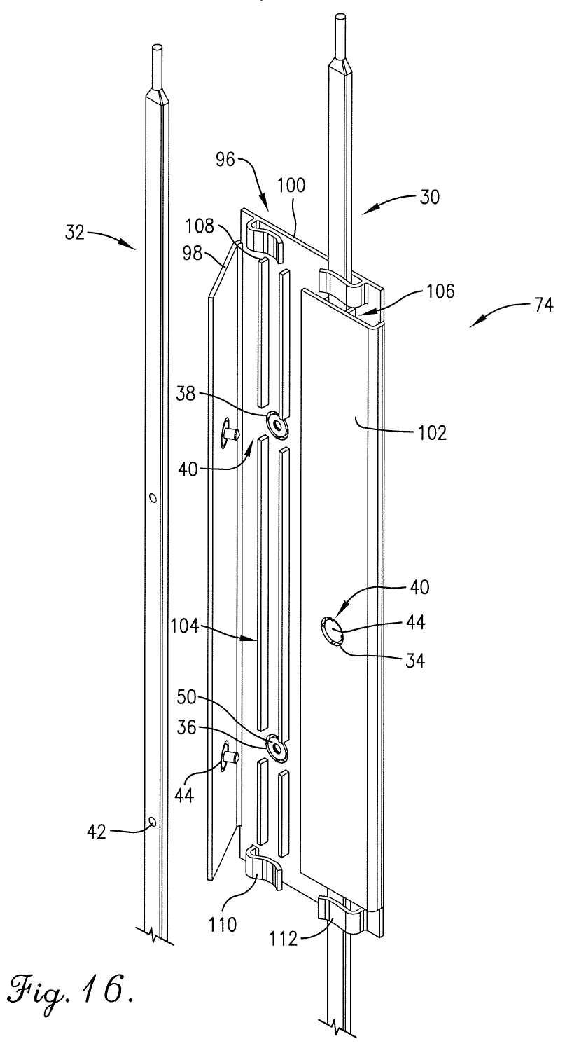

Other embodiments of the kit, illustrated in FIGS. 15 and 16, include a location guide 74 comprising a tri-fold 96. The tri-fold 96 comprises left, middle, and right sections 98,100,102 and is preferably formed of cardboard, heavy paper-stock, flexible plastic, or other suitable material. The identifiers 34-38 are secured to the tri-fold 96 at locations spaced to suitably position the identifiers on the shoelace 20. The middle section 100 of the tri-fold 96 further includes left and right tracks 104,106, with each track comprising spaced, parallel guides 108 for receipt of the shoelace 20 there between, as best illustrated in FIG. 16. The left and right sections 98,102 of the tri-fold 96 are operable to rotate around a hinged line to cover at least part of the middle section 100, as best illustrated in FIG. 16.

The tri-fold 96 also includes securement fasteners, such as clips 110 positioned directly below and above each track 104,106 for securing the shoelace 20 within the guides 108 of the tracks 104,106. The clips 110 may comprise any suitable fastener that easily receives and holds the shoelace 20 within the guides 108. In the illustrated embodiment, the clips 110 comprise a flexible, curved arm 112 open on one side and secured to the middle section 100 of the tri-fold 96 on the other side. The shoelace 20 can be guided through the open end of the clip 110. Due to the flexible, curved configuration of the clip 110, a body of the clip will press down by friction force to secure the shoelace onto the tri-fold 96.

The identifiers 34-38 are located on the tri-fold at positions such that when securing the identifiers to the shoelace 20, the identifiers 34-38 comprising rivet assemblies 40 are secured to the appropriate location on the shoelace 20 to assist with tying one's shoes, as discussed in more detail below. As best illustrated in FIG. 16, the upper segment 44 of a first of the rivet assemblies 40 is secured within the right section 102 of the tri-fold 96. Similarly, the opposing, lower segment 50 (not shown) of the first rivet assembly 40 is secured within the middle section 100 of the tri-fold 96. The upper segments 44 of second and third rivet assemblies 40 are secured within the left section 98 of the tri-fold 96, and the opposing lower segments 50 of the second and third rivet assemblies 40 are secured within the middle section 100. The upper and lower segments 44,50 of the rivet assemblies 40 are secured within the tri-fold via any suitable means, such as perforations, adhesives, etc.

To position the identifiers 34-38 at the correct location on the shoelace 20, a first crossing of the tie sections 30,32 is performed, such that the tie sections 30,32 are crossed over each other to form the crossing 86 adjacent the upper end of the eyelets 84. This is the common first step to tying one's shoe. Once crossed, the second tie section 32 will be on the left-hand side of the tri-fold 96 when viewed from the front, as illustrated in FIG. 16, and the first tie section 30 will be on the right-hand side of the tri-fold 96 when viewed from the front. A bottom of the tri-fold 96, with the front of the tri-fold facing toward a toe of the shoe 82, is then positioned adjacent a tongue of the shoe at the upper end of the eyelets 84 where the crossing 86 is located, as best illustrated in FIGS. 2 and 15. The first and second tie sections 30,32 are then secured within the right and left tracks 106,104 of the tri-fold 96, as illustrated in FIG. 16, such that the first tie section 30 is secured within the right track 106, and the second tie section 32 is secured within the left track 104. Any remaining length of shoelace 20 extending from a top of the tri-fold 96 is allowed to hang loosely, and the amount of shoelace extending in FIG. 16 is not intended to be to scale. The tie sections 30,32 are secured or embedded within the tracks 106,104 by guiding the shoelace 20 within the clips 110, as described above.

As noted above, the identifiers 34-38 are positioned on the tri-fold at spaced locations such that when the tie sections 30,32 are guided within the tracks 106,104, the upper and lower segments 44,50 of the rivet assemblies 40 can be friction or snapped fit or otherwise secured onto the shoelace 20 in the proper location. In one embodiment of the invention, the second identifier 36 is located approximately three inches and more preferably two inches from the bottom of the tri-fold 96, and the third identifier 38 is located approximately five inches and more preferably four inches from the second identifier 36. The third identifier 38 is then located approximately five inches and more preferably four inches from the top of the tri-fold 96. The first identifier 34 is located approximately five inches and more preferably four inches from the bottom of the tri-fold 96. It is noted that the placement of the identifiers in FIG. 16 is not necessarily to scale.

Once the tie sections 30,32 are secured within the tracks 106,104, the rivet assemblies 40 are secured to the tie sections 30,32 via the friction fit discussed above. With the bottom of the tri-fold positioned at the crossing 86, and the tie sections 30,32 secured tautly within the tri-fold 96, the identifiers 34-38 are located at the correct positions along a length of the tie sections 30,32 for accomplishing the method of assisting a person in learning to tie shoes.

Those skilled in the art will understand that the present invention is susceptible to many variations in terms of structural components. As explained above, an almost limitless variety of shoelace types may be used in the invention, regardless of the material thereof (cloth, leather, or even flexible metal). In addition, virtually any type of identifier can be used, so long as the first tie section is uniquely identified vis-a-vis the second tie section. The preferred rivet assemblies are especially useful in this context, in that they provide both a visual and a tactual identification; thus, the instructional shoelaces can be used by vision-impaired individuals. However, if desired other visually or tactually perceptible indicators could be used, such as color coding, or shoelace surface irregularities. Also, while it is preferred that the second tie section be equipped with a pair of identifiers to assist in proper loop formation, such is not an essential attribute of the invention.

Experience with the instructional shoelaces of the invention has confirmed that they greatly assist an individual in learning to properly tie shoes. A principal difficulty in acquiring this skill is the confusion which can arise between the individual tie sections of a shoelace, and the sequence of grasping and manipulating the respective sections. This difficulty is overcome in the present invention by the unique identification of the first tie section so as to clearly distinguish it from the second tie section. As such, the learner can be instructed to grasp the second tie section (which is readily distinguishable owing to the unique identification of the first tie section) and to form the starting loop. Thereupon, the learner will grasp the first, uniquely identified tie section to complete the tie.

I claim:

1. A tie shoe assembly for assisting a person in learning how to tie a shoelace, said assembly comprising:
a tie shoe having a series of shoelace-receiving eyelets; and
an instructional shoelace threaded through said eyelets and presenting first and second opposed tie sections extending from the eyelets, each of the first and second tie sections having an outer tip spaced from said eyelets,
said first tie section having a distinct, perceptible identifier located between said eyelets and said tip thereof which is operable to identify the first tie section and to distinguish the first tie section from the second tie section.

2. The assembly of claim 1, said identifier comprising a rivet assembly secured to said first tie section.

3. The assembly of claim 1, said identifier located substantially midway between said eyelets and said tip.

4. The assembly of claim 1, said second tie section having a pair of spaced apart perceptible identifiers thereon between said eyelets and said second tie section tip.

5. The assembly of claim 4, said second tie section identifiers comprising a pair of rivet assemblies secured to the second tie section.

6. The assembly of claim 1, said identifier being visually perceptible.

7. The assembly of claim 1, said identifier being tactually perceptible.

8. An instructional shoelace comprising an elongated flexible body presenting a pair of tips respectively adjacent each end of the body, said body having a central section adapted to be threaded through the eyelets of a tie shoe, and first and second tie sections between said central section and said tips, said first tie section having a distinct, perceptible identifier located between said central section and said tip thereof, said identifier operable to identify the first tie section and to distinguish the first tie section from the second tie section.

9. The shoelace of claim 9, said second tie section having a pair of spaced apart perceptible identifiers thereon between said central section and said second tie section tip.

10. The shoelace of claim 10, said first tie section identifier being located between said pair of identifiers on said second tie section, when said tips are placed adjacent each other and said shoelace is drawn taut.

11. The shoelace of claim 11, said first tie section identifier comprising a rivet assembly secured to the first tie section.

12. A kit for modifying a shoelace so as to provide an instructional shoelace useful to assist a person in learning to tie shoelaces, said shoelace comprising an elongated flexible body presenting a pair of tips adjacent each end of the body, said body having a central section adapted to be threaded through the eyelets of a tie shoe, and first and second tie sections between said central section and said tips, said kit comprising:
a first distinct, perceptible identifier attachable to said first tie section between said central section and said tip thereof, said identifier operable to identify the first tie section and to distinguish the first tie section from the second tie section;
a location guide to which is secured the identifier,
said location guide including securement fasteners for receiving at least one of said first and second tie sections,
said identifier positioned on the location guide, such that upon securement of at least one of said first and second tie sections to the location guide,
said identifier is properly aligned with the at least one of said first and second tie sections; and
an instruction guide providing instructions for manipulating the modified shoelace, the instruction guide listing at least the following steps—
crossing said first and second tie sections;
forming a loop in said second tie section at a point spaced from said crossing;
grasping said first tie section and passing the first tie section around said loop so that a portion of the first tie section is disposed between said crossing and said loop; and
simultaneously pulling loop and said first tie section portion in opposite directions to complete the tying of said shoelace.

13. The kit of claim 12, said second tie section having a pair of spaced apart perceptible identifiers thereon between said eyelets and said second tie section tip, and the loop-forming step provided on said instruction guide further including the step of placing said spaced apart perceptible identifiers on said second tie section in adjacent relationship.

14. The kit of claim 12, said first identifier comprising a rivet assembly attachable to said first section.

15. The kit of claim 12, said location guide comprising a tri-fold having left, middle and right sections, said right section having said first identifier secured thereon, and said left section having second and third identifiers secured thereon.

16. The kit of claim 15, said second and third identifiers attachable to said second tie section at spaced apart locations thereon.

17. The kit of claim 16, said second identifier being spaced from a bottom of the tri-fold approximately two inches and said third identifier being spaced from a top of the tri-fold approximately four inches.

18. The kit of claim 12, further including a hole-stamping device for stamping at least one hole in the shoelace for receipt of at least one identifier.

19. The kit of claim 14, said first identifier being visually perceptible.

20. The kit of claim 14, said first identifier being tactually perceptible.
